(19) United States
(12) Patent Application Publication
(10) Pub. No.: US 2006/0182130 A1
(43) Pub. Date: Aug. 17, 2006

(54) Method and system for establishing an audio/video communication session across zones

(75) Inventors: Roni Even, Tel Aviv (IL); Amit Keynan, Kfar Saba (IL); Michael Tucker, Austin, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Polycom, Inc., Pleasanton, CA (US)

(21) Appl. No.: 11/334,261

(22) Filed: Jan. 18, 2006

Related U.S. Application Data
(60) Provisional application No. 60/646,340, filed on Jan. 24, 2005.

(51) Int. Cl. H04L 12/56; H04L 12/28

(52) U.S. Cl. 370/401

(57) ABSTRACT

The present disclosure provides methods of establishing communication between endpoints located in different gatekeeper zones. An electronic message comprising (i) an alias for a first endpoint and (ii) an address of a first gatekeeper associated with the first endpoint is delivered from a first computer associated with the first endpoint to a second computer associated with a second endpoint. Alternatively, the deliverance of the message can occur within the same computer. Upon receiving the message, a second endpoint is instructed to replace its original gatekeeper address with the gatekeeper address listed in the message. Subsequently, the second endpoint uses the alias of the first endpoint to establish communication with the first endpoint.

### CROSS-REFERENCE TO RELATED APPLICATIONS

This non-provisional application claims the benefit of priority of provisional application 60/646,340, filed Jan. 24, 2005, the entire contents of which are incorporated herein by reference.

### FIELD OF THE INVENTION

The present invention relates to the field of videoconferencing over an Internet Protocol (IP) network. More particularly, the present invention provides methods and systems for using non-routable addresses such as but not limited aliases or URIs to make calls across different zones in an IP network.

### BACKGROUND

Companies and organizations commonly use audio/video conferencing and multipoint conferencing to reduce traveling expenses and save time. It is becoming common to conduct such conferencing sessions over computer networks, such as IP networks.

IP networks are typically divided into a plurality of zones. Zones may be private or public. Private IP networks (i.e., Intranets) may belong to private corporations and only authorized users can access those networks. Other zones may be public, for example, zones belonging to an IP service provider (ISP) that provides access to the Internet. IP networks capable of providing audio/video services incorporate assets such as gateways, Multipoint Control Units (MCU), gatekeepers, etc.

Users use endpoints to participate in audio/video sessions. An endpoint is a terminal on a network, capable of providing real-time, two-way audio/visual communication with other terminals or a multipoint control unit (MCU). An endpoint may provide speech only; speech and video; or speech, data and video communications. Exemplary endpoints include Polycom VSX 7000, available from Polycom, Inc. A MCU is a conference controlling entity located in a node of the network or in a terminal which receives several media channels from access ports. A MCU processes audio/visual and data signals according to certain criteria, and distributes them to the connected channels. Examples of MCUs include the MGC-100, which is available from Polycom Inc., the assignee of the present invention.

Information communicated between terminals and/or a MCU includes control signals, indicators, audio, video and/or data. Such communications are typically communicated via a standard protocol, such as H.323. A more thorough definition of an endpoint (terminal) and a MCU can be found in the website of the International Telecommunication Union (“ITU”), referencing standards such as H.323.

An IP zone may include a plurality of endpoints. An IP zone is typically associated with a gatekeeper. Each endpoint in a zone may register at and be serviced by the associated gatekeeper. A gatekeeper provides address resolution, which includes translating an endpoint alias into IP address of the endpoint. Exemplary endpoint alias may include E.164 telephone number, H.323ID, URL, and EMAIL etc. The endpoints are registered to the gatekeeper through the Registration Request signaling of the H.225 (ITU-T) Registration, Admission and Status protocol. Usually an endpoint is registered with only one gatekeeper. This gatekeeper may be provisioned in the configuration of the endpoint as the default gatekeeper of the endpoint.

According to the current standards, an endpoint's alias is unique in a gatekeeper zone. Usually a caller endpoint attempts to initiate a communication session (audio and/or audiovisual session) with another endpoint by using an alias of the second endpoint. A request for an address resolution is transferred to the caller endpoint's associated gatekeeper to translate, based on internal tables, the alias of the second endpoint into a routable address. If the alias is not found in the internal tables, the gatekeeper may apply for translation to one or more neighbor gatekeepers which are distributed over the network. However, different gatekeeper zones may have identical endpoint aliases. Furthermore, a gatekeeper in one zone may not be familiar with the IP addresses associated with endpoints in another gatekeeper zone. Hence, since the same alias may be used in different gatekeeper zones, address resolution received from a neighbor gatekeeper may not belong to the requested endpoint. If no gatekeeper can translate the alias, then the call is rejected.

To overcome the above problem, a user may use a routable IP address instead of the alias of the second endpoint. However a person might find it difficult to obtain and manage routable IP addresses. Therefore, there is a need for system and method that use endpoint aliases to automatically establish a communication session between two endpoints registered in different gatekeeper zones that do not have trust relation.

### SUMMARY

Accordingly, the present disclosure provides a calling method between endpoints across different zones in an IP network system. In one embodiment, each endpoint is associated with an Auto Dial Application that may run on a computer at the endpoint or on any other computer that can communicate with the endpoint over an IP network. The auto dial application and the endpoint may communicate via an API (Application Program Interface) of the endpoint, for example. In another embodiment, the auto dial application may be part of the endpoint.

An exemplary auto dial application includes a requesting module and a responding module. The requesting module is adapted to receive a request from a first endpoint (a requester) to call a second endpoint (a responder). Upon receiving the request, an electronic message including a calling couple may be created. The electronic message may be an email, instant message, SMS, etc. An exemplary calling couple may include the alias of an endpoint and the address of a gatekeeper associated with the endpoint. The address of the gatekeeper is a routable address. Exemplary addresses can be IP addresses, URIs (Uniform Resource Identifiers), etc. In one embodiment, the calling couple embedded in the electronic message may be invisible to the responder and only a link (e.g. a soft key) is visible to the responder. Alternatively, the calling couple may be added automatically at the end of each email as part of a user signature including title, phone number, email address, etc. The electronic message is sent to a computer that is associated with the responder.

The computer that is associated with the responder can be a desktop, laptop computer, or any computing device that can run the auto dial application. The computer can also be the computer of the responder endpoint. The electronic message can be sent over a back channel to the responder's endpoint. In one embodiment in which the associated computers have telephone capabilities, a communication session may be established using a telephone connection over telephone POTS (Plain Old Telephone Service) as the back channel (public channel). A calling couple may also include additional information, such as an authentication token for the gatekeeper, that may be needed to establish the call.

Upon receiving the electronic message at the responder's endpoint, the responder may accept the invitation and call the requester's endpoint. Accepting the invitation may be done by activating a responding module in the responder endpoint or a computer associated with the endpoint. The responding module is adapted to perform a number of functions, including communicate with the responder endpoint; request the IP address of the current associated gatekeeper that is written in the configuration of the responder endpoint; store the IP address of the current associated gatekeeper; process the electronic message; retrieve the IP address of the requester's gatekeeper from the message; and reconfigure the responder endpoint to use the requester's gatekeeper as its associated gatekeeper. Accordingly, the responding module would instruct the responder's endpoint to start a session with the requester's endpoint using the requester's gatekeeper to translate the alias of the requester's endpoint into a routable IP address. The responding module may also be adapted to monitor the existence of the communication session and instruct the responder's endpoint to re-register with its original gatekeeper at the end of the session based on stored IP address.

In one embodiment, the responding module application may be included within the electronic message. For example, the responding module may be in the form of executable file, java script, etc.

In another embodiment, the electronic message created by the requesting module of the auto dial application can be sent to a computer that is not an endpoint, e.g. a desktop computer connected over an IP network in the same zone of the responder's endpoint. The desktop computer may get the electronic message (e.g. an email, instant message, etc.) that embeds the calling couple. Upon initiation, the responding module of the auto dial application may ask the user to select an endpoint as the responder's endpoint for the call. Selecting an endpoint may be done by defining the IP address of the selected endpoint.

The user of the responder endpoint may save the calling couple received from the requester's endpoint in an address book (cache). Whenever the responder wishes to call the requester, the saved calling couple may be retrieved from the address book and be used to activate the responding module to establish communication with the requester's endpoint.

In order to improve the security of the network in a certain zone, the calling couple may contain an IP address of a Session Border Controller (SBC) instead of the gatekeeper of the zone. The SBC is adapted to route the call to the gatekeeper of the zone. Alternatively, a second gatekeeper (an hosted gatekeeper) located outside of the zone may be used in the calling couple. The hosted gatekeeper or the SBC are defined as a neighbor gatekeeper to the internal gatekeeper.

In another embodiment, a requester from zone ‘A’, who uses a first endpoint, may call a responder in zone ‘B’, who uses a second endpoint, by sending an invitation (an email or instant message, for example) comprising an auto dial batch and calling couple via a back channel. If the responder accepts the invitation, then the auto dial batch is activated and is pointed to an endpoint used by the responder.

The auto dial batch may detect the type of the responder's endpoint, determine (e.g. by using an API of the responder's endpoint) its default gatekeeper IP address, and instruct the responder's endpoint to replace its default gatekeeper address with that of a requester's gatekeeper and register at the requester's gatekeeper. After replacing the gatekeeper, the auto dial batch instructs the responder's endpoint to call the requester's endpoint. At the end of the call the auto dial batch retrieves the IP address of the original gatekeeper and instructs the responder's endpoint to place that original gatekeeper address as the default gatekeeper. Then the auto dial batch is terminated. Defining the type of the responder's endpoint may be done manually by requesting identification by the user. Alternatively, the auto dial batch may automatically request the endpoint to define its type.

An exemplary embodiment may be used in a system that is using SIP communication protocol instead of H.323. In such a case a SIP Proxy can be used instead of a Gatekeeper and a SIP URI can be used instead of the alias. In such embodiment of the present invention a calling couple may include the SIP URI of an endpoint and the address of a SIP Proxy that is associated with the endpoint. In addition the message may include a token for the SIP Proxy. More information on SIP can be found at the Internet Engineering Task Force (IETF) website.

### BRIEF DESCRIPTION OF THE DRAWINGS

Exemplary embodiments of the present invention will be more readily understood from reading the following description and by reference to the accompanying drawings, in which:

FIG. 1 is a diagram illustrating a general topology of a H.323 system with endpoints and Gatekeeper zones.

FIG. 2 is a block diagram illustrating relevant elements of an auto dial application.

FIG. 3 is a block diagram illustrating relevant elements of an auto dial batch.

FIG. 4 illustrates a flowchart showing relevant steps in an exemplary method of using an auto dial application to prepare an invitation for a communication session.

FIG. 5 illustrates a flowchart showing relevant steps in an exemplary method of using an auto dial application to accept an invitation for a communication session and establish the communication session.

FIG. 6 illustrates a flowchart showing relevant steps in an exemplary method of using an auto dial batch to prepare an invitation for a communication session.

FIG. 7 illustrates a flowchart showing relevant steps in an exemplary method of using an auto dial batch to accept an invitation for a communication session and establish the communication session.

### DETAILED DESCRIPTION

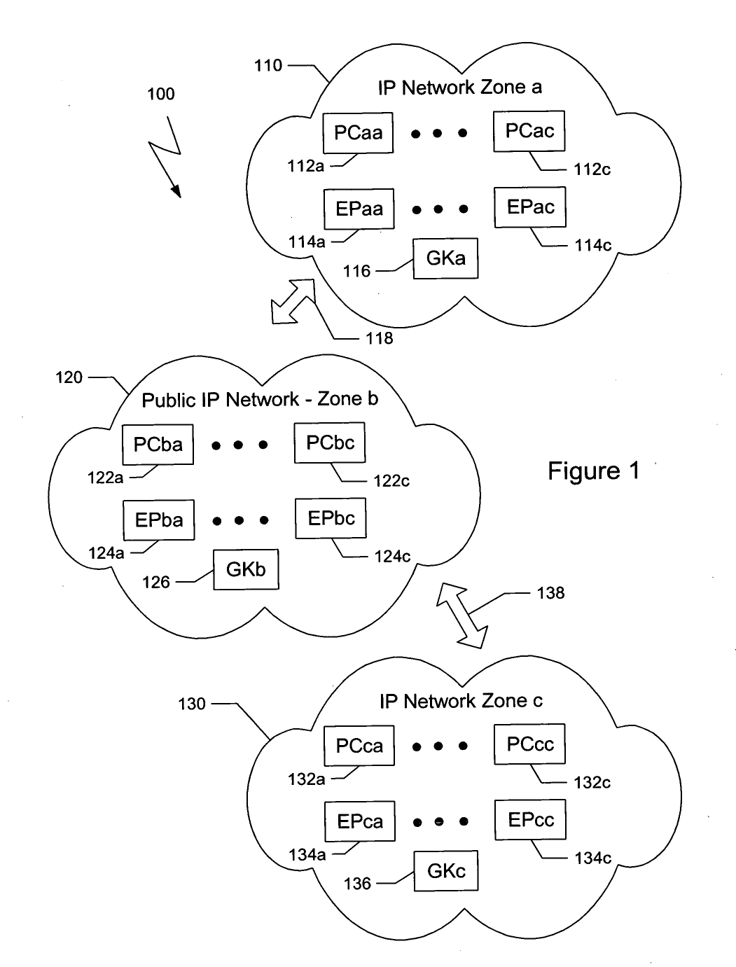

FIG. 1 is a block diagram showing some of the elements of a communication system 100. Communication system 100 is based on H.323 ITU.T protocol. System 100 offers multimedia service over a packet network. The packet network includes enterprise network 110, enterprise networks 130 and metropolitan-area networks 120 etc. Each network may include Gatekeepers (GKs) 116, 126 & 136; a plurality of H.323 endpoints (EPs), Endpointₐₐ (114a) to Endpoint_{ac} (114c), Endpoint_{ba} (124a) to Endpoint_{bc} (124c), and Endpoint_{ca} (134a) to Endpoint_{cc} (134c); a plurality of computers (PCs) PCaa (112a) to PCac (112c), PCba (122a) to PCbc (122c), and PCca (132a) to PCcc (132c). We note here that though the letters PC are used to denote computers, any computing device can be used, including computing devices that are built into an endpoint. In addition, a network may include gateways (not shown); Multipoint Control Units (MCU) (not shown), etc. In case that the MCU replaces one of the endpoints in the connection the MCU can use an embodiment of the disclosed system as one of the endpoints. Alternative embodiments of the conference system may have other components and/or may not include all of the components shown in FIG. 1.

The H.323 endpoints may provide any combination of speech, data, and video communication. Exemplary endpoint can be an IP Phone, or a multimedia endpoint such as, but not limited to, POLYCOM VSX™, etc. More information about communications between endpoints and/or MCUs over different networks, as well as information describing signaling, control, compression, and how to set up a video call can be found at the International Telecommunication Union (“ITU”) website, referencing protocol H.323 or at the Internet Engineering Task Force (IETF) website referencing SIP. The H.323 endpoint registers at its own gatekeeper and is serviced by that gatekeeper. For example, endpoints 114a-c are registered at gatekeeper 116; endpoints 124a-c are registered at gatekeeper 126; and endpoints 134a-c are registered at gatekeeper 136. Among other task the gatekeeper provides address resolution that includes translating an endpoint alias into an IP address of the endpoint. The endpoint alias is registered to the gatekeeper using the Registration Request message of the H.225 Registration, Admission and Status protocol.

Computers 112a-c, 122a-c, and 132a-c may be personal computers, laptop computers, desktop computers, notebook computers, mainframe computers, dumb terminals, computers that control the endpoints, or any other type of computing device that can be connected over at least one of the IP networks 110, 120 & 130 and can communicate with one or more endpoints located in the same gatekeeper zone. For example computer 112c may communicate with endpoint 114c. Alternatively, the computer and its associated endpoint are embedded in the same unit.

A computer may be associated with one or more endpoints. The computer may communicate with an endpoint via an application interface module (API) module that is part of the endpoint. The computers may be adapted to run an exemplary software module, auto dial application or auto dial batch, which operates according to an exemplary embodiment of the present invention. The software module is adapted to using endpoint aliases to establish a communication session between endpoints located in different gatekeeper zones.

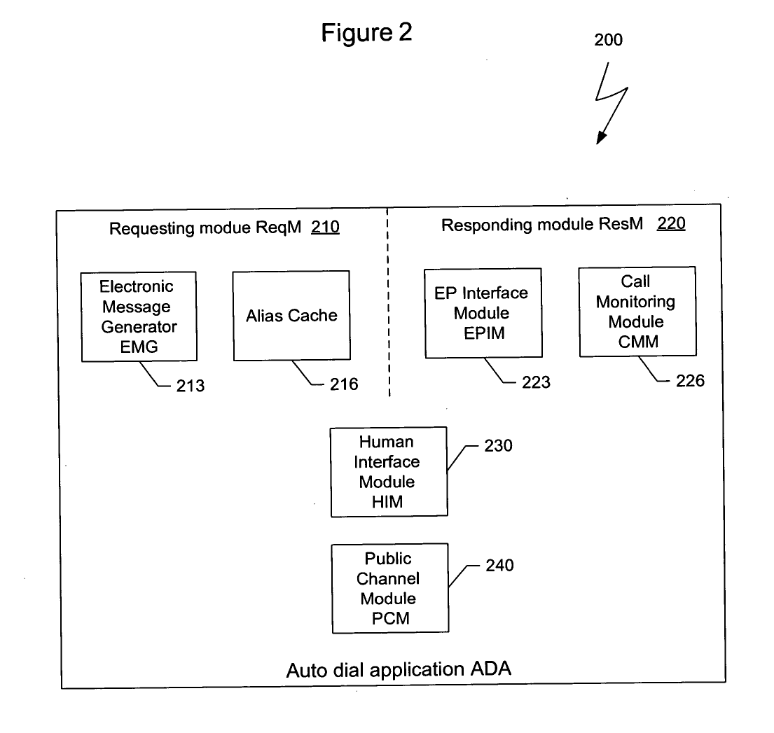

Each one of the computers 112a-c, 122a-c, and 132a-c may be associated with a user and have human interface capabilities. A computer that is located in one gatekeeper zone may communicate with a computer in another gatekeeper zone via a back channel (e.g., a public channel). For example computer 112a may communicate with computer 132c via networks 110, 120 & 130 by using email, instant messages, SMS, etc. Although the example illustrated in FIG. 1 shows three gatekeeper zones 110, 120 & 130 with three endpoints and three computers in each zone, it will be appreciated that any number other than three may be used with the present invention. More information on the operation of computers 112a-c, 122a-c, and 132a-c in establishing communication session between endpoints located in different zones is disclosed below in conjunction with FIGS. 2-7.

In case that communication system 100 is based on SIP protocol, each one of the gatekeepers 116,126 and 136 is replaced by SIP proxy and URI of the endpoint is used instead of the alias.

FIG. 2 illustrates a block diagram with relevant elements of an exemplary auto dial application (ADA) module 200 which is adapted to using endpoint aliases to establish a communication session between two H.323 endpoints located in different gatekeeper zones that do not have trust relation, e.g. between endpoint 114a and endpoint 134c (FIG. 1). Auto dial application 200 may be a software application running in computer 112a and computer 132c. Exemplary auto dial application 200 may comprise a requesting module (ReqM) 210, a responding module (ResM) 220, a human interface module (HIM) 230, and a public channel module (PCM) 240. The human interface module 230 and the public channel module 240 may be used by the requesting module 210 and the responding module 220. Human interface module 230 may use a graphic human interface (GUI) to communicate with a user. The requesting module 210 may comprise an electronic message generator (EMG) 213 and an alias cache 216. The responding module 220 may comprise an endpoint interface module (EPIM) 223 and a call monitoring module (CMM) 226.

The auto dial application 200, or aspects of the auto dial application 200, may be stored in a fixed storage medium (e.g. a disc, flash memory, a read-only memory etc.). During installation of auto dial application 200, the IP address of a gatekeeper associated with an endpoint as well as an alias of the selected endpoint are stored in the auto dial application. Additional information such as authentication token of a gatekeeper may also be stored. During operation of a computer, one or more of the software modules may be retrieved from the fixed storage medium and loaded into a temporary memory such as a random-access memory. Requesting module 210 may be used in a computer that is associated with a user who requests the session (a requester). Responding module 220 may be used in a computer associated with a user who receives the invitation (a responder). In case of an ad-hoc call, both requesting module 210 and responding module 220 of the same auto dial application 200 may be activated.

Alias cache 216 may have a table of endpoint aliases for endpoints that have been connected by the auto dial application 200. Each entry in the cache is associated with an endpoint and may include three fields: one for the endpoint alias, one for the IP address of a gatekeeper associated with the endpoint, and one for the address (in the public channel) that belongs to a computer associated with the user of the endpoint. The address in the public channel may be an email address of the user, for example. Additional fields that may be listed in the cache include, but are not limited to, authentication token, user name, telephone number, and organization name.

Requesting module 210 may be invoked by a user (a requester) such as the user of computer 112a who wants to invite another user (a responder) from another gatekeeper zone, for example the user of computer 132c, to a communication session using H.323 endpoints 114a & 134c respectively. Upon initiation, electronic message generator 213 together with the human interface module 230 may prompt the requester to define the requested time, the name and public address of the responder. If more than one endpoint can be used by the requester, then the requester may be prompted to select an endpoint. The endpoint may be defined by its alias or selected from a pop-up list. Alternatively, the endpoint is defined once during the installation of auto dial application 200.

If the communication session is an ad-hoc session, alias cache 216 may be searched for an entry that is associated with the responder. If an entry is found, the alias and the gatekeeper address associated with the responder are retrieved from the cache and transferred to the responding module 220 of the requester's auto dial application 200. If an entry is not found or the call is not an ad-hoc call, then electronic message generator 213 may retrieve the gatekeeper address associated with the requester as well as the alias of the requester's endpoint (endpoint 114a, for example). Electronic message generator 213 may create a calling couple that includes the gatekeeper address associated with the requester and the alias of the requester's endpoint. The calling couple of the requester, the public address of the responder, and the time of the session are transferred to the public channel module 240. The calling couple may also include an authentication token for the gatekeeper associated with the requester if needed.

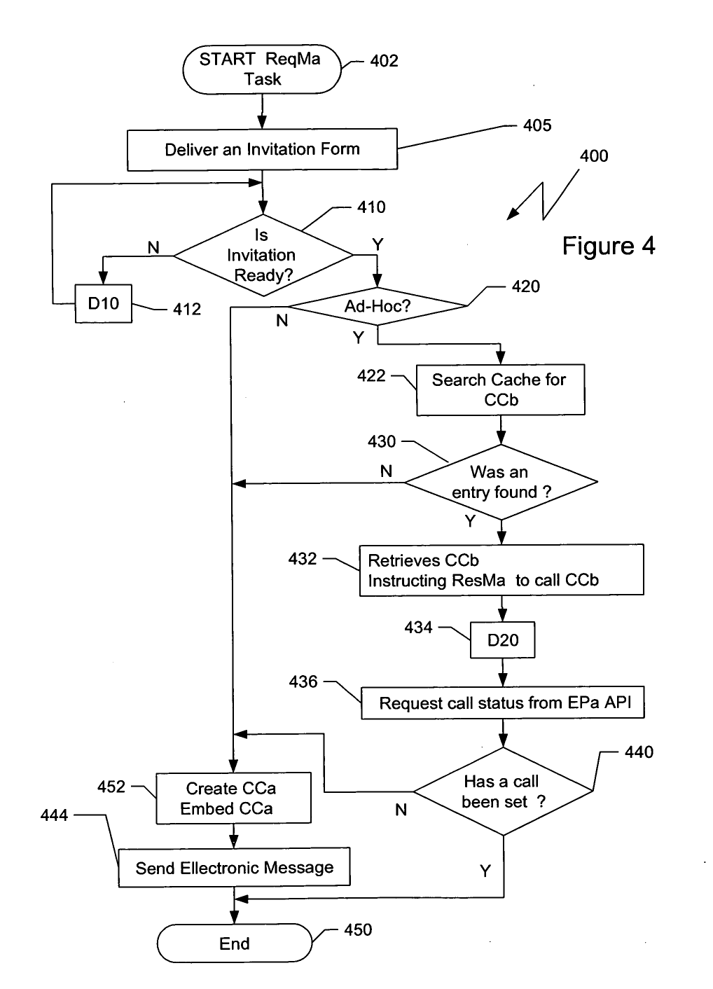

Public channel module 240 may be an application that is plugged in a common communication application such as an email application, OUTLOOK™, MICROSOFT MESSENGER™, YAHOO MESSENGER™, etc. Public channel module 240 may be adapted to prepare and send an electronic message (e.g. an email, an instant message, etc) to the responder's public address. The electronic message may include an invitation to the communication session, the time and the calling couple of the requester. The electronic message may include a link or an executable file that is operative to invoke the responding module 220 in the responder's computer. More information on the operation of requesting module 210 is disclosed below in conjunction with FIG. 4.

On the other side of the connection, the invitation is received by the public channel module 240 in the responder's computer, and is displayed (using its human interface module 230) to the responder. If the responder accepts the invitation, then appropriate human interface module 230 may prompt the responder to select an H.323 endpoint to be used during the session. Alternatively, the human interface module 230 may be configured to point a certain endpoint. Then the received calling couple and the alias of the selected endpoint are transferred to endpoint interface module 223 which is adapted to communicate with the selected endpoint via an API of the endpoint. Communication with the endpoint may be conducted over an IP network, for example.

Endpoint interface module 223 may process the received calling couple. The alias of the requester's endpoint (endpoint 114a, for example) and the IP address of the requester's gatekeeper (gatekeeper 116, for example) are retrieved from the calling couple. Endpoint interface module 223 may request the responder's endpoint to deliver the IP address of its configured gatekeeper (gatekeeper 136, for example). This original gatekeeper address may be saved in the endpoint interface module and/or at the endpoint itself. The responder's endpoint is then instructed to write the IP address of the requester's gatekeeper 116 as the default address and to register with gatekeeper 116. Then endpoint interface module 223 may instruct the responder's endpoint to call the requester's endpoint.

Call monitoring module 226 may be invoked after the call is established. Call monitoring module 226 may use the API of the responder's endpoint to monitor the existence of the call. When the call is terminated, endpoint interface module 223 is informed by call monitoring module 226, and the responder's endpoint is instructed to reconfigure its default gatekeeper with the IP address of its original gatekeeper (gatekeeper 136, for example) and to register at gatekeeper 136.

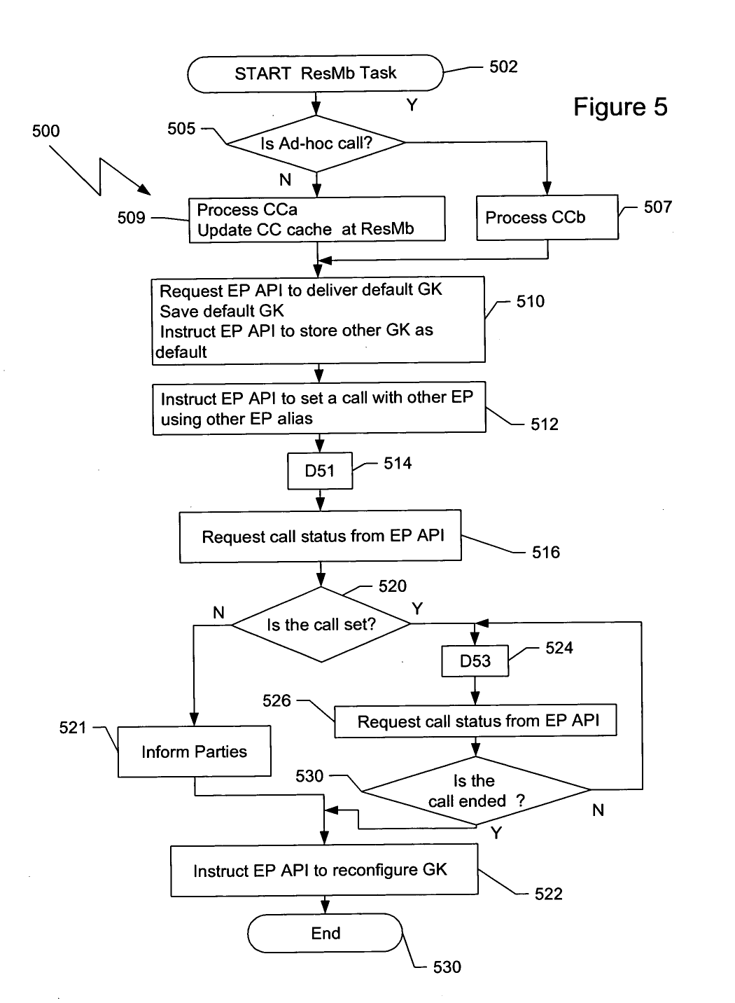

If the association between an endpoint and a computer is not unique and cannot be configured during the installation of auto dial application 200, endpoint interface module 223 and call monitoring module 226 may be modified to handle one or more type of endpoints. More information on the operation of responding module 220 is disclosed below in conjunction with FIG. 5.

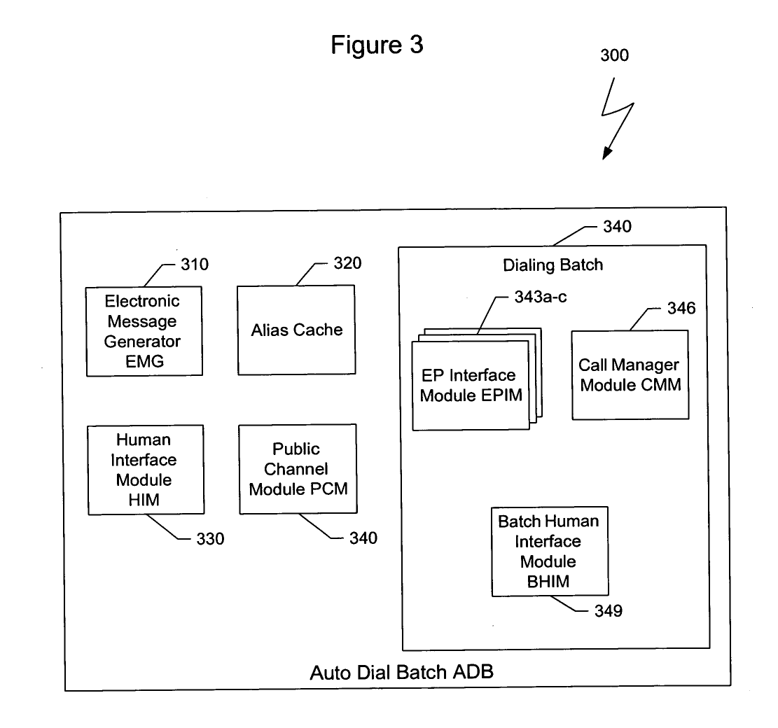

FIG. 3 illustrates a block diagram with relevant elements of an exemplary embodiment of an auto dial batch module (ADB) 300 adapted to use endpoint aliases to set up communication session between two H.323 endpoints located in two different gatekeeper zones, e.g. between a requester who uses endpoint 114a and a responder who uses endpoint 134c. Auto dial batch module 300 may be a software application running in a computer associated with a requester; for example, computer 112a.

An exemplary auto dial batch 300 may include an electronic message generator 310, an alias cache 320, a human interface module 330, a public channel module 340, and a dialing batch 350. The dialing batch may be sent embedded with an electronic message to a computer associated with a responder; for example, computer 132c. When the dialing batch 350 is initiated, it may communicate with a responding endpoint 134c and instruct the endpoint to call endpoint 114a, for example. In one embodiment, the operation of electronic message generator 310, alias cache 320, and public channel module 340 may be similar to equivalent modules of auto dial application 200 (213, 216 & 240 respectively). Human interface module 330 may be slightly modified from human interface module 230 and may include only the section that interfaces with a requester.

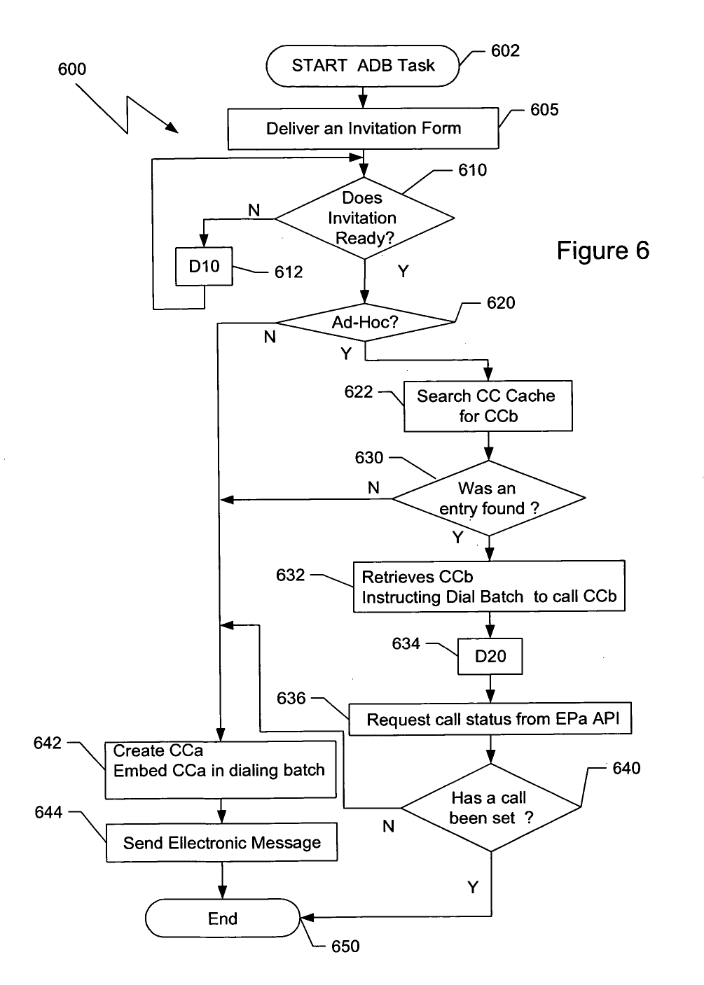

An exemplary dialing batch 340 may include, among other modules, one or more endpoint interface module 343a-c, a call manager module 346, and a batch human interface module (BHIM) 349. In one embodiment, the operation of call manager module 346 may be similar to the operation of call monitoring module 226 (FIG. 2). Batch human interface module 349 may include a responder human interface section of human interface module 230 that requests identification of an endpoint. More information on the operation of auto dial batch 300 is disclosed below in conjunction to FIGS. 6 & 7.

FIG. 4 illustrates the steps in an exemplary method 400 for preparing an invitation to a communication session between two H.323 endpoints. Method 400 may be implemented by requesting module 210 (FIG. 2). Auto dial application 200 may be initiated when the computer is powered on, and the parameters of the user and one or more associated endpoints are retrieved. The parameters may include, among other parameters, alias of one or more associated endpoints, the types of the endpoints, the IP address of a gatekeeper associated with the zone in which the one or more endpoints are connected, authentication token if needed, user's name, email address, etc. If more than one endpoint can be associated with the computer, then a list of associated endpoints and their parameters may be retrieved from storage. The above parameters may also be provided during installation of auto dial application 200. These parameters are stored and a user needs to invoke requesting module 210 to start a communication session.

Method 400 is invoked at 402 when a user (a requester) wants to set up a communication session with a party (a responder) having a H.323 endpoint located in a different gatekeeper zone. An invitation form to be completed by the requester is retrieved at 405 and displayed to the requester. The invitation form may include fields for date, time, subject, responder's name, responder's public address (which can be used by the electronic message), a pop up menu with a list of requester's associated endpoints selectable by the requester, etc. In an alternate embodiment, the invitation may include a pop-up list of potential parties to be selected by the requester. The list may be based on information in the alias cache 210 (FIG. 2).

A decision 410 determines whether the invitation has been completed by the requester and is ready to be sent. If it is not, method 400 may wait 412 for a period ‘D10’ and check again at 410. Delay ‘D10’ may be in the range of a few seconds to a few minutes. If the invitation is ready, a decision 420 determines whether the call is an ad-hoc call. The decision may be based on checking the date and time fields in the invitation. Alternatively, the decision may be based on an ad-hoc field included in the invitation. If the call is not an ad-hoc call, then method 400 proceeds to step 442.

If the call is an ad-hoc, then alias cache 216 is searched 422 for an entry (i.e., calling couple, CCb) that is associated with the responder. The search may be based on responder's name and/or public address. At the end of the search a decision 430 determines whether an entry was found. If an entry was not found, then method 400 proceeds to step 442.

If an entry associated with the responder is found a calling couple that belongs to the responder is retrieved from the cache 432. The calling couple of the responder may include the alias of the responder's endpoint and the IP address of a gatekeeper associated with the zone in which the responder's endpoint is located. The calling couple of the responder may also include an authentication token, if exist. The calling couple of the responder is transferred to the responding module 220 (FIG. 2) of the same auto dial application 200 in the requester's computer. Responding module 220 is instructed to direct the requester's endpoint to call the endpoint defined by the calling couple. More information on the operation of responding module 220 is disclosed below in conjunction with FIG. 5.

Method 400 may wait, to enable the process of call set up, 434 for a period of ‘D20.’ Period ‘D20’ may be in the range of a few seconds to a few minutes. At the end of the delay a status request 436 may be sent to the API of the requester's endpoint. On receiving the status, a decision 440 determines whether the call has been established. If the call has been set up, then method 400 terminates at 450; otherwise, method 400 proceeds to step 452.

At step 452 requesting module 210 may prepare a calling couple (CC) associated with a selected endpoint used by the requester for the session. This calling couple may include the alias of a requester's endpoint, the IP address of a gatekeeper associated with the zone in which the requester's endpoint is located, and an authentication token if needed. An electronic message may be prepared 452. The electronic message may include the calling couple and the invitation. The electronic message is sent at 444 via a public channel according to the responder's public address to a computer associated with the responder. Method 400 then terminates 450. In some exemplary embodiments the message or at least part of the message can be encrypted.

FIG. 5 is a flow chart illustrating an exemplary method 500 for instructing one H.323 endpoint to call another H.323 endpoint located in a different zone. Exemplary method 500 may be performed by an associated computer running a responding module 220 (FIG. 2). The method can be initiated to establish an ad-hoc call upon receiving a calling couple from a requesting module 210 located in a requester's computer (step 432 in FIG. 4). Alternatively, the method is initiated when a responder user accepts an invitation to participant in a communication session. The invitation includes a calling couple (the calling couple of the requester's endpoint). Upon accepting the invitation, responding module 220 in the responder's computer is initiated and method 500 starts at 502. If the invitation is for a future date, the responder may save the invitation in a scheduling application that may invoke the invitation at the appropriate time. The scheduling application may be the same application that is used for preparing the invitation. An exemplary application is MICROSOFT OUTLOOK™.

At step 505 a decision is made to determine whether the call is an ad-hoc call that was initiated over the same computer. If the call is an ad-hoc call, then the calling couple is processed and the alias of the responder's endpoint, the IP address of responder's gatekeeper, and authentication token, if exist, are stored in an appropriate location in the memory of the requester's computer, and method 500 proceeds to step 510. If the call is not an ad-hoc call, then the received electronic message is processed at the responder's computer. At 509, the calling couple is processed, and the alias of the requester's endpoint, the IP address of the requester's gatekeeper, authentication token (if exist) and the public address of the requester are stored in the cache of auto dial application 200 in the responder's computer associated with the responder. Storing the information in the cache may include checking whether a similar entry already exists in the cache. New entry in the cache may be used in the future when the responder makes an ad-hoc call with the requester.

At step 510 a connection between the associated computer and its associated endpoint may be set up using the API of the associated endpoint. In the case of an ad-hoc call, the computer and its associated endpoint are the requester's equipments. In the case of a non ad-hoc call, the computer and its associated endpoint are the responder's equipments. If two or more endpoints can be used, the user may be requested to select one endpoint to be used as the associated endpoint for the call.

The associated endpoint is requested 510 to deliver the IP address of its default gatekeeper. The default gatekeeper IP address may be saved in an appropriate location in the memory of the computer. Alternatively, or in addition, the associated endpoint may also save the IP address of the default gatekeeper. The API may use the saved IP address of the gatekeeper in case of power failure or the connection between the computer and the associated endpoint fails. The IP address of the other gatekeeper that was embedded in the calling couple is transferred to the API of the associated endpoint with a command to make this IP address the current gatekeeper of the associated endpoint and to register with the gatekeeper that its address was embedded in the calling couple.

After replacing the IP address of the gatekeeper, the alias of the other endpoint embedded in the calling couple is sent at 512 to the API of the associated endpoint, with a command to set up a H.323 session with the other endpoint based on the alias. Method 500 may then wait 514 for a period ‘D51’, which is an estimated time needed to establish a connection between the endpoints. Period ‘D51’ may be in the range of a few seconds to a few minutes. At the end of the delay a request for call status may be sent 516 to the associated endpoint's API. Alternatively, the endpoint may be configured to inform the computer when the connection is set.

At the end of the delay a decision is made 520 to determine whether the call has been successfully established. If the call is not successfully made, method 500 may inform the parties at 521. A message indicating that the connection fails may be displayed on the screen of the computer. In addition, a failure message may be sent via the public channel to be displayed by the other user's computer. After informing the users, method 500 proceeds to step 522.

If the call has been successfully set up, method 500 may periodically check the status of the call. At the end of a delay ‘D53’ 524, a request for call status 526 may be sent to the associated endpoint's API. Period ‘D53’ may be in the range of a few seconds to a few minutes. Alternatively, the endpoint may be configured to inform the computer when the call is terminated. Upon receiving the status, a decision is made at 530 to determine whether the call has been terminated. If the call is not terminated, method 500 returns to step 524 and waits for another period ‘D53’. If the call is terminated, then the original gatekeeper IP address saved in step 510 is retrieved from the memory at 522. This original gatekeeper IP address and a command to store the address as default gatekeeper and to register with the original gatekeeper are sent to the API of the associated endpoint. Method 500 then terminates at 530.

FIG. 6 illustrates an exemplary method 600 of using auto dial batch 300 to prepare an invitation to a communication session between two H.323 endpoints. Auto dial batch 300 may be initiated when the computer is powered on, and parameters of the user and one or more associated endpoints are retrieved. The parameters may include, among other parameters, the alias of the associated one or more endpoints, the types of the endpoints, the IP address of a gatekeeper associated with the zone in which the one or more endpoints are connected, user's name, email address, etc. If more than one endpoint can be associated with the computer, then a list of relevant endpoints and their parameters may be retrieved from memory storage. Alternatively, the above parameters may be provided during installation of auto dial batch 300. These parameters are stored and auto dial batch 300 is waiting to be invoked to start a communication session.

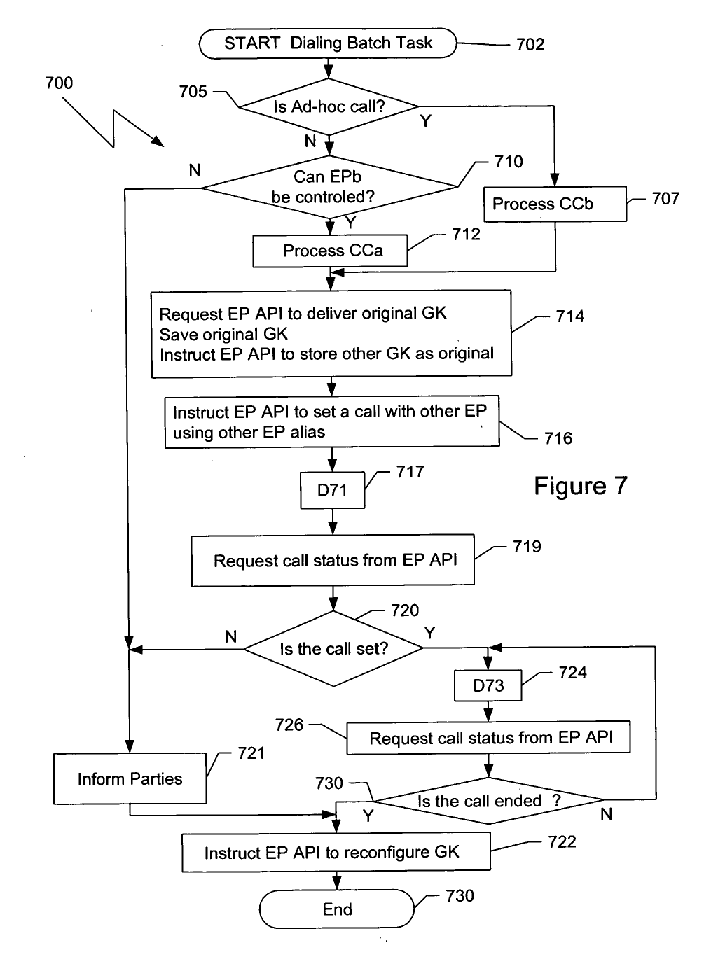

The operation of method 600 can be similar to that of method 400 described above in conjunction with FIG. 4. The main differences between the two methods are in steps 632 & 642 versus steps 432 & 442 respectively. At step 632 dialing batch 340 (FIG. 3) is used to set up an ad-hoc call instead of responding module 220 (FIG. 2). At step 642 the dialing batch with the calling couple may be embedded within an electronic message. The dialing batch may be sent as an executable file attached to the electronic message. More information on the operation of the dialing batch is disclosed below in conjunction with FIG. 7.

FIG. 7 illustrates an exemplary method 700 of using dialing batch 340 to instruct one H.323 endpoint to call another H.323 endpoint located in another gatekeeper zone. Exemplary method 700 may be performed by an associated computer that received the dialing batch 340. In the case of an ad-hoc call, the operation of method 700 can be similar to that of method 500 disclosed above in conjunction with FIG. 5. If the call is not an ad-hoc call, then, among others activities, method 700 may differ from method 500 in three ways. Method 700 may be executed by a computer that is not previously adapted to perform the functionality of the exemplary embodiment of the present invention. Therefore, after accepting the invitation the dialing batch may start an installation process. The second issue relates to the type of the associated endpoint because the associated endpoint may not be adapted to execute the exemplary embodiment of the present invention. Therefore, the type of the endpoint has to be checked. The last difference between method 500 and 700 is that there is no need to update a cache in method 700.

Method 700 can be initiated to establish an ad-hoc call upon receiving a calling couple from the alias cache 320 located in the same computer. In such a case there is no need to install the dialing batch 340 since it is part of auto dial batch 300 already installed in the computer. Alternatively, method 700 is initiated when a responder accepts an invitation to participant in a communication session with another endpoint. The invitation includes the dialing batch 340 with a calling couple listing parameters of the requester's endpoint. Upon accepting the invitation and initiating the dialing batch 340, method 700 is started at 702 and may initiate an installation process within the responder's computer. Alternatively, installation is not needed. The dialing batch can be started immediately, for example, using Java script. In case the invitation is for a future date, the responder may save the invitation in a scheduling application that may invoke the invitation at the appropriate time. The scheduling application may be the same application that is used for preparing the invitation. Exemplary applications include MICROSOFT OUTLOOKT™.

At step 705 a decision is made to determine whether the call is an ad-hoc call. In case of an ad-hoc call, the calling couple is retrieved from the requester's cache (step 632 of FIG. 6). The retrieved calling couple is processed at 707, and the alias of the responder's endpoint, the IP address of the responder's gatekeeper, and the authentication token (if exist) are stored in an appropriate location in the memory of the requester's computer. Method 700 then proceeds to step 714.

If the call is not an ad-hoc call, then a decision is made (on the responder side) at 710 to determine whether the responder's endpoint is adapted to be controlled by method 700. In one embodiment, the decision may be reached by prompting the responder to select an H.323 endpoint for the session and to define the type and the model of the endpoint. Based on the responder's answer, method 700 may determine whether one of its endpoint interface modules 343a-c (FIG. 3) can communicate with and control the operation of the endpoint. Alternatively, a list of types of endpoints that can be controlled may be displayed to the responder. The responder may select from the list or may choose the option of ‘OTHER ENDPOINT’. Selecting ‘OTHER ENDPOINT’ means that the responder's endpoint cannot be controlled by the dialing batch. In yet another embodiment, the task of endpoint identification may be done automatically. Method 700 may initiate endpoint interface modules 343a-c one at a time. Each of the endpoint interface modules may try to communicate with the responder's endpoint. The first endpoint interface module that succeeds in communicating with the responder's endpoint remains active. If none of the endpoint interface modules 343a-c can communicate with the responder's endpoint, the responder's endpoint cannot be controlled by the dialing batch.

If 710 the responder's endpoint cannot be controlled by method 700, the parties are informed at step 721. If 710 the responder's endpoint can be controlled, then the received electronic message is processed at 712. The calling couple comprises the alias of the requester's endpoint and the IP address of the requester's gatekeeper, which are processed and stored in an appropriate memory location in the responder's computer.

At step 714 a connection between a computer and its associated endpoint is set up using the API of the associated endpoint. In the case of an ad-hoc call, the computer and its associated endpoint are the requester's equipment. In the case of a non ad-hoc call, the computer and its associated endpoint are the responder's equipment. If two or more endpoints can be used, the user may be requested to select one endpoint to be used for the call. Steps 714 to 730 of method 700 operate in similar manners as those of method 500 (from step 510) which are described above in conjunction with FIG. 5.

In this application, the words “unit,” “element” and “module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware.

Those skilled in the art will appreciate that the present invention can be implemented in the form of additional software residing in the endpoints or the MCU for performing the methods disclosed herein. Additional hardware can be added to the endpoints or the MCU, or additional software or hardware can be distributed among the endpoints or the MCU.

It will be appreciated that the above described methods may be varied in many ways, including, changing the order of steps, and the exact implementation used. It should also be appreciated that the above described description of methods and apparatus are to be interpreted as including apparatus for carrying out the methods and methods of using the apparatus.

The described embodiments comprise different features, not all of which are required in all embodiments of the invention. Some embodiments of the present invention utilize only some of the features or possible combinations of the features. Different combinations of features noted in the described embodiments will occur to persons skilled in the art. The scope of the invention is limited only by the following claims.

What is claimed is:

1. A method for establishing communication between a first endpoint associated with a first gatekeeper and a second endpoint associated with a second gatekeeper, the method comprising:
delivering an electronic message to a computer associated with the second endpoint, the message comprising an alias of the first endpoint and an address of the first gatekeeper;
instructing the second endpoint to replace an address of the second gatekeeper with an address of the first gate keeper; and
instructing the second endpoint to establish communication with the first endpoint based on the alias of the first endpoint.

2. The method of claim 1, further comprising instructing the second endpoint to register at the first gatekeeper.

3. The method of claim 1, further comprising instructing the second endpoint to replace the address of the first gatekeeper with the address of the second gatekeeper after the communication is terminated.

4. The method of claim 3, further comprising instructing the second endpoint to register at the second gatekeeper.

5. The method of claim 1, wherein the electronic message further comprises authentication token for the first gatekeeper.

6. The method of claim 1, wherein the electronic message is an email or an instant message.

7. The method of claim 1, wherein the electronic message is delivered via a public channel.

8. The method of claim 1, wherein the communication between the first endpoint and the second endpoint is based on H.323 protocol.

9. The method of claim 8, wherein the address of the first gatekeeper and/or the second gatekeeper is an IP address.

10. The method of claim 1, wherein the communication between the first endpoint and the second endpoint is based on SIP protocol.

11. The method of claim 10, wherein the first gatekeeper represents a first SIP proxy and the second gatekeeper represents a second SIP proxy.

12. The method of claim 10, wherein the alias of the first endpoint represents a URI of the first endpoint and the alias of the second endpoint represents a URI of the second endpoint.

13. A method for establishing communication between a first endpoint associated with a first gatekeeper and a second endpoint associated with a second gate keeper, the method comprising:
instructing the second endpoint to replace an address of the second gatekeeper with an address of the first gatekeeper; and
causing the second endpoint to establish communication with the first endpoint based on the alias of the first endpoint.

14. The method of claim 13, wherein instructing the second endpoint to replace an address of the second gatekeeper with an address of the first gate keeper comprises:
delivering an electronic message to a computer associated with the second endpoint, the message comprising an alias of the first endpoint and an address of the first gatekeeper, and
delivering to the computer instructions to replace an address of the second gatekeeper with an address of the first gatekeeper.

15. The method of claim 14, further comprising instructing the second endpoint to register at the first gatekeeper.

16. The method of claim 14, wherein the instructions to replace the address of the second gatekeeper with the address of the first gatekeeper are contained in an executable file.

17. A method for establishing communication between a first endpoint associated with a first gatekeeper and a second endpoint associated with a second gate keeper, the method comprising:
receiving at a computer associated with the second endpoint an electronic message comprising an alias of the first endpoint and an address of the first gatekeeper;
reconfiguring the second endpoint so that the first gatekeeper is associated with the second endpoint; and
establishing communication with the first endpoint based on the alias of the first endpoint.

18. The method of claim 17, wherein the electronic message further comprises authentication token for the first gatekeeper.

19. The method of claim 17, wherein the electronic message is an email or an instant message.

20. The method of claim 17, wherein reconfiguring the second endpoint comprises executing a computer application.

21. The method of claim 17, wherein reconfiguring the second endpoint so that the first gatekeeper is associated with the second endpoint; and establishing communication with the first endpoint based on the alias of the first endpoint comprises executing an executable batch file.
